(19) United States
(12) Patent Application Publication
(10) Pub. No.: US 2024/0183154 A1
(43) Pub. Date: Jun. 6, 2024

(54) SYSTEM AND METHOD FOR PRODUCING A DRYWALL BOARD WITH TAPERED SIDES

(71) Applicant: Jerry MOSCOVITCH, Toronto (CA)

(72) Inventor: Jerry MOSCOVITCH, Toronto (CA)

(21) Appl. No.: 18/285,880

(22) PCT Filed: Apr. 7, 2022
(86) PCT No.: PCT/IB2022/053290

§ 371 Date: Oct. 6, 2023

Related U.S. Application Data
(60) Provisional application No. 63/172,473, filed on Apr. 8, 2021.

(51) Int. Cl. E04C 2/04; B28B 11/08

(52) U.S. Cl. CPC E04C 2/043; B28B 11/0863

(57) ABSTRACT

Described herein is a system and method to produce a taper on a drywall board to facilitate taping and compounding where two boards abut. A groove is formed on the back side of a drywall board, resulting in a first gypsum-containing segment hingeably connected to a second gypsum-containing segment. A taper is created by rotating the segments until they meet, and then removing excess material.

### BACKGROUND OF THE INVENTION

### 1. Field of the Invention

The present invention is directed to drywall boards and in particular to making drywall boards with tapered ends.

### 2. Description of the Related Art

Drywall or gypsum boards are used in modern construction as a fire-resistant smooth cladding surface for interior walls or ceilings. A drywall board is made of gypsum material sandwiched between two sheets of drywall paper or liner. In a typical manufacturing process, drywall board is formed by mixing calcium sulphate hemihydrate (known as stucco) with water and other additives to produce a slurry, which is deposited between two parallel sheets of drywall paper that form an envelope. The envelope is extruded through an orifice. The extrusion forms a continuous ribbon, several hundred feet in length, of a gypsum slurry core that is enclosed by the two sheets of drywall paper. The parallel sheets of paper are provided from a roll that continuously unwinds to supply the board line. The two sheets of drywall paper are typically glued together near the edges of the board. The ribbon is cut into individual boards. A board kiln completes the drying process. The result is a rectangular shaped drywall board having four sides.

During a typical manufacturing process, the drywall boards are extruded so that of the four sides of the drywall board, two opposite sides are tapered. This is achieved by shaping the slurry so that when the slurry sets, a slight taper or slope is created near the edge of the board, resulting in the thickness at the edge of the board being less than the thickness near the center of the board.

In the construction of buildings, drywall boards are commonly abutted to build interior walls and corners. By having tapered sides, it is easier to apply and process the joint compound near the region where the boards abut including because the taper creates a slight recess that can accept the compound. Tape is pressed into the joint compound along the full length of the taper. More joint compound is then placed over the tape before the first sanding of the resulting joint is performed. Iterations of joint compound application and sanding are performed as needed.

However, boards often need to be cut to various sizes, and when a board is cut the tapered side is typically lost. When a cut edge without a taper is abutted to another board, the job of compounding becomes more difficult because no space is present on the board for accepting compound. Nevertheless, compound still needs to be applied, but without the tapered side, more feathering and sanding of the compound is required to make the joint ultimately appear as seamless as is practically possible. This makes the job of installing drywall without a tapered side more arduous, time consuming and costly.

### SUMMARY OF THE INVENTION

It is an aspect of the present invention to address this problem that arises when the manufactured tapered side of a board is cut and discarded or when a side of a board was never tapered to begin with, resulting in having to treat a seam where no taper is present to facilitate the compounding of joints.

Described herein is a drywall board having a tapered end. By “end” is meant any one of the regions of the board proximal to an edge. For example, in a rectangular shaped board with four sides that form the perimeter, the ends of the board refer to the four regions near the edges. The region that is tapered is preferably on the finishing side of the board where compound is applied.

The board includes a first gypsum-containing segment and a second gypsum-containing segment abutting the first segment at a boundary therebetween. A finishing drywall liner integrally covers an area on a front side of the first segment and a front side of the second segment. A seam is located where the first segment and the second segment abut, the seam being parallel to the edge and on a back side of the first and second segments. An adhesive can be applied at the boundary to affix the second segment to the first segment.

The above aspects can be attained by a method of tapering an end of a drywall board, the method comprising: providing a drywall board having a back side with a framing drywall liner, a front side with a finishing drywall liner, and an edge; creating a groove on the back side of the drywall board parallel to the edge, wherein the groove a) has a void therein, b) has a depth that extends to but does not sever the finishing drywall liner, and c) gives rise to a hinge that includes the finishing drywall liner, said hinge connecting a first segment of the drywall board on one side of the groove to a second segment of the drywall board on another side of the groove, such that the second segment includes the edge; and closing the void in the groove by rotating at least one of the first segment and the second segment about the hinge.

According to an additional aspect a drywall board is provided having a tapered end proximal to an edge of the board, comprising: a first gypsum-containing segment; a second gypsum-containing segment abutting the first segment at a boundary therebetween; a finishing liner integrally covering an area on a front side of the first segment and a front side of the second segment; and a seam located where the first segment and the second segment abut, said seam being parallel to the edge and on a back side of the first and second segments

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIGS. 1A-C show a drywall board with a tapered end, according to the principles of the present invention;

FIG. 2 outlines steps in a method for making a drywall board with a tapered end, according to the principles of the present invention;

FIGS. 3A-E show the appearance of the drywall board as the steps in FIG. 2 are executed; and

FIGS. 4A-C show three embodiments corresponding to three different areas where drywall liner can be applied to the drywall board of FIGS. 1A-C, according to the principles of the present invention.

### DETAILED DESCRIPTION OF THE PREFERRED EMBODIMENTS

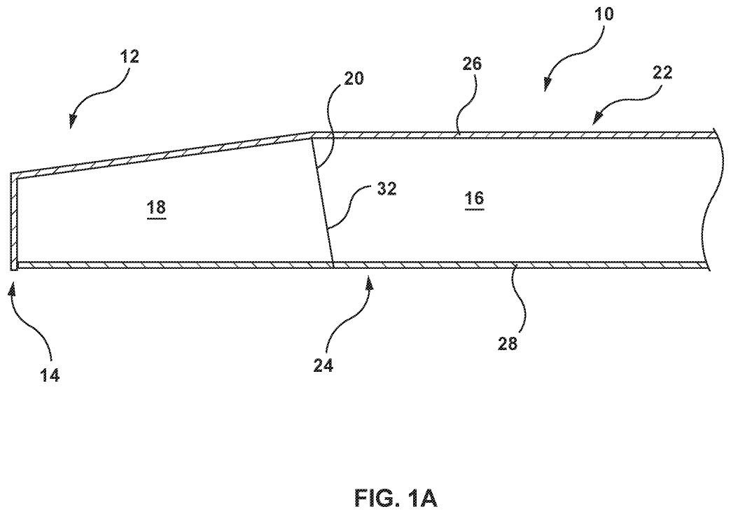

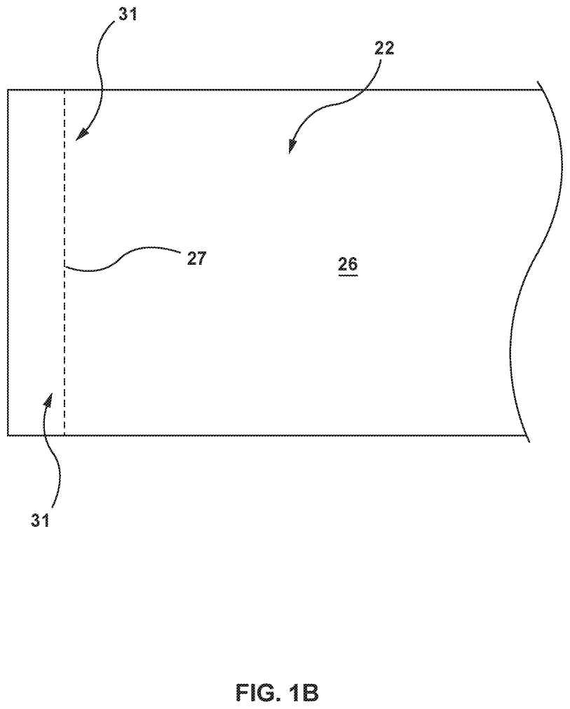

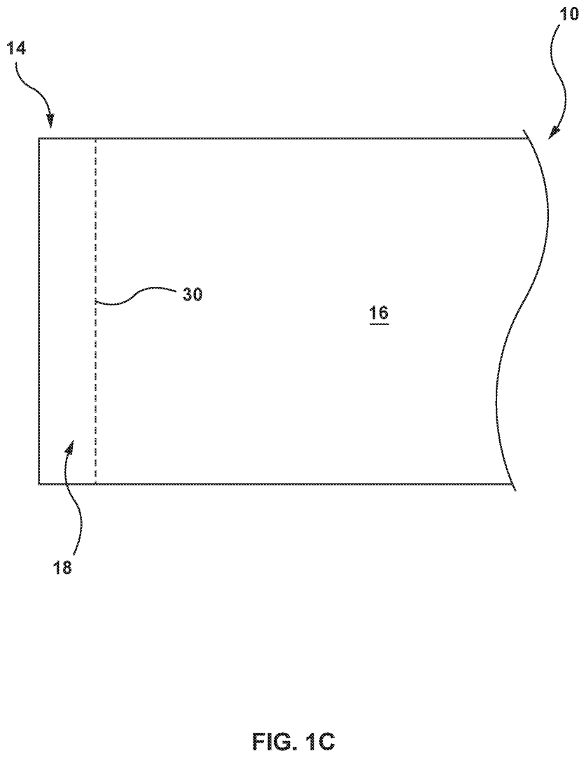

With reference to FIGS. 1A and 1B, a drywall board 10 having a tapered end 12 proximal to an edge 14 of the board 10 is shown. The drywall board 10 includes a first gypsum-containing segment 16 and a second gypsum-containing segment 18 abutting the first segment 16 at a boundary 20 therebetween. The drywall board has a front side 22 (or finishing side) and a back side 24 (or framing side). The front side 22 of a drywall board is the side that is exposed in a room when the drywall board is installed therein and which is typically finished with paint, wallpaper, etc. The back side 24 is the side of the drywall board 10 that is not exposed in the room and the side that is closest to the framing elements such as studs or joists in the room. Normally, the back side 24 of the drywall board 10 is placed against the studs, for example, to build a wall. The board 10 is then fastened to the studs with drywall screws or nails.

A finishing liner 26 integrally covers an area 31 on the front side 22 of the first segment 16 and the second segment 18. In FIG. 1B, a dashed line is used to indicate a nominal hinge axis 27, which will be explained in more detail below. The hinge axis 27 is located in or proximal to the finishing drywall liner 26 near the boundary 20. It should be understood, however, that in reality the finishing liner 26 covers the boundary 20 and is smooth there so that no cut appears on the front side 22. This is consistent with the side view of FIG. 1A where the finishing liner 26 is shown to be uncut above the boundary 20.

The finishing drywall liner 26 on the front side 22 is typically exposed to an observer inside a room. As mentioned above, the finishing drywall liner 26 can be finished with paint or wallpaper, for example. A framing drywall liner 28 on the back side 24 is typically not visible to an observer inside a room. The framing drywall liner 28 faces and is in contact with framing structures, such as wood or metal studs or joists when the drywall board 10 is installed. Sheets of finishing drywall liner 26 may be of a different quality than sheets of framing drywall liner 28. Commercially available drywall boards typically consist of gypsum material sandwiched between the finishing drywall liner 26 and the framing drywall liner 28.

Unlike the finishing drywall liner 26, which is integral at the boundary 20, the framing drywall liner 28 is severed at the boundary 20, as shown in FIG. 1A. In particular, a seam 30 is located where the first segment 16 and the second segment 18 abut. The seam 30 is parallel to the edge 14 and, as mentioned, is located on the back side 24, where the first segment 16 and second segments 18 meet. An adhesive 32, such as a hot melt adhesive, is disposed at the boundary 20 between the first segment 16 and the second segment 18. The adhesive 32 serves to affix the second segment 18 to the first segment 16.

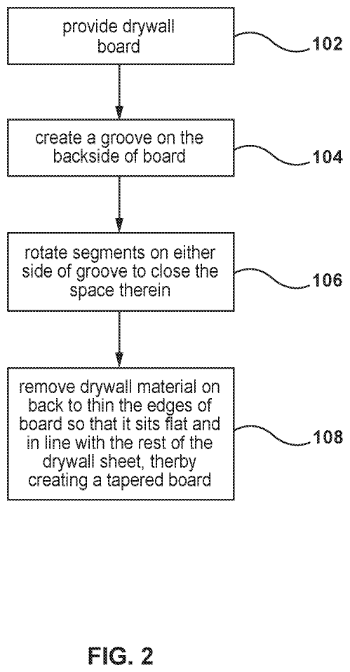

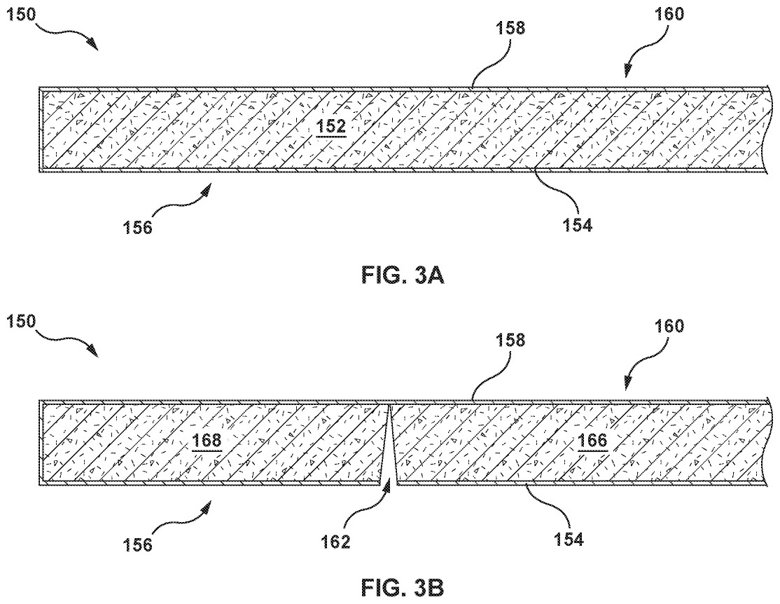

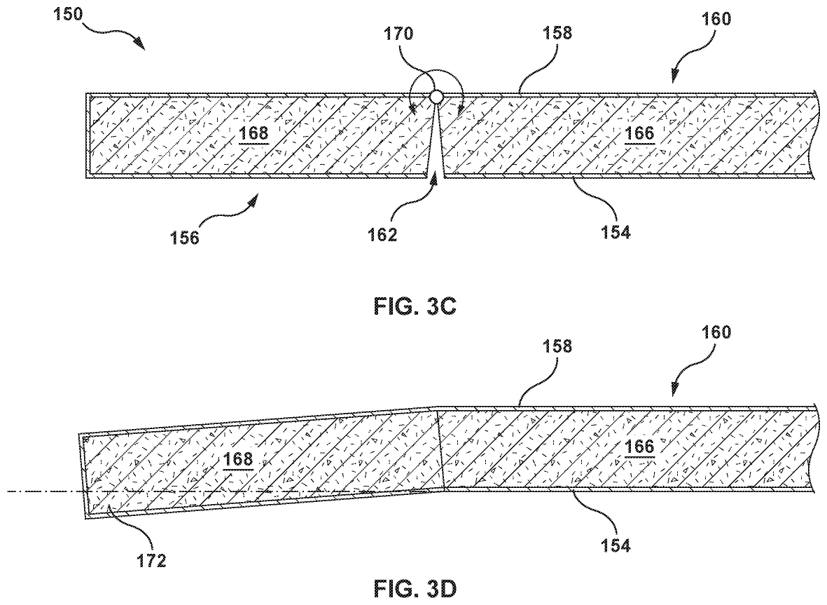

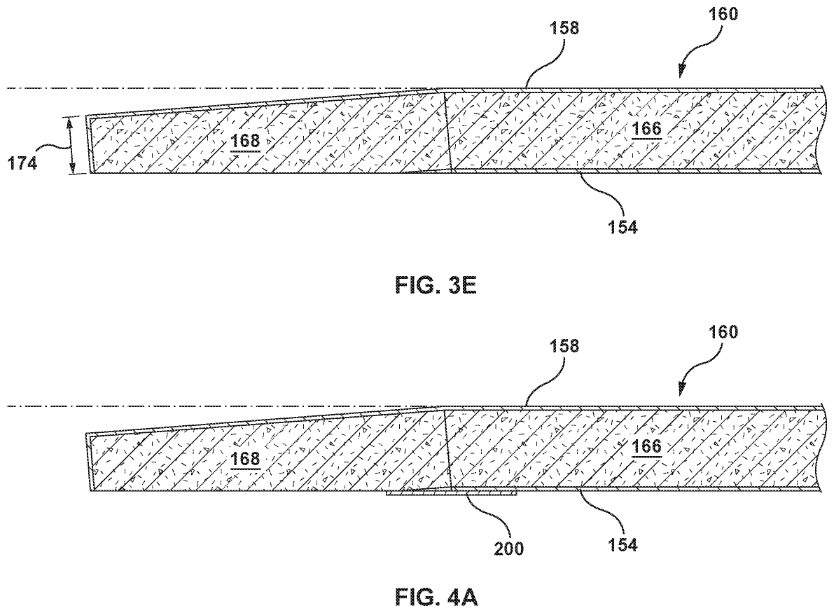

A method of manufacturing the drywall board 10 shown in FIGS. 1A-C will now be provided. With reference to FIG. 2, a method of tapering an end of a drywall board is described. In step 102, a drywall board having a back side with a framing drywall liner, a front side with a finishing drywall liner, and an edge is provided. In step 104, a groove is created on the back side of the drywall board parallel to the edge. (The groove is shown as element 162 in FIG. 3B.) The groove can have several shapes, such as rectangular or V-shaped profile, depending on the cutting tool cross section. The groove also has a void therein. The void allows the first segment, which is shown in FIGS. 1A-C as element 16, and the second segment, which is shown as element 18, to rotate about the hinge axis 27 (see FIG. 1B) over a range of angles. Preferably, the void should not be overly wide so as to require excessive amounts of adhesive and time to fill the void. The groove has a depth that extends to but does not sever the finishing drywall liner. Thus, the finishing drywall liner 26 is left intact above the boundary 20, as shown in FIG. 1A. The hinge is primarily comprised of a thin segment of the finishing drywall liner above the boundary 20. Thus, the hinge, which comprises finishing liner material, connects a first segment of the drywall board on one side of the groove to a second segment of the drywall board on another side of the groove. The second segment 18 includes the edge 14 referenced above. In step 106, the void in the groove is closed by rotating at least one of the first segment and the second segment about the hinge axis. Finally, in step 108, the edge is thinned by removing drywall material from the back side of the second segment to thereby make a tapered end that includes the edge.

Advantageously, by following the foregoing steps, a taper of the drywall board is created by removing drywall material from the framing side of the board. The drywall paper on the finishing side is left unscathed. This is a desirable feature because it is the drywall paper on the finishing side that is visible to an observer in a room where the board is used to make a wall (or ceiling) after the paper is usually finished with paint, wallpaper, etc. By leaving the paper on the finishing undisturbed, this ensures that the integrity of the paper is maintained for paint treatment and esthetic appeal.

In FIGS. 3A-3E, the appearance of the drywall board as the previous steps are taken is shown. In FIG. 3A, a drywall board 150 is shown having a gypsum core 152 sandwiched between a framing drywall liner 154 on the back side 156 and a finishing drywall liner 158 on the front side 160. Various tools can be used to create a groove 162 in the gypsum core, such as a circular saw (or other type of saw), or high-speed router. With reference to FIG. 3B, a router has been used to create a narrow, V-shaped groove 162 in the gypsum core 152 by routing into the back side 156, through the framing liner 154. Instead of a V-shaped groove, other groove shapes are possible, such as a rectangular groove. The groove 162 separates a first segment 166 of the board 150 from a second segment 168. The groove extends from the back side 156 to the finishing drywall liner 158. The finishing drywall liner 158 is not cut but remains intact. This allows the drywall liner 158 near the groove 162 to serve as a hinge, allowing the first segment 166 and the second segment 168 to rotate about a hinge axis 170 that is perpendicular to the page containing FIG. 3B. This is schematically shown in FIG. 3C where the hinge axis 170, which is perpendicular to the page, intersects the page where the shaded circle is shown.

The V-shaped groove angle 162 dictates how much the first segment and the second segment can rotate before they collide to abut each other. In one embodiment, it suffices that the V-shaped groove angle is less than or equal to five degrees. Other appropriate angles, whether larger or smaller, are also possible. Instead of a V-shaped groove, a router can be used to create a hollow or void in the gypsum material. Alternatively, a circular saw, or other type of appropriate saw, can be used to cut a slit on the back side 156.

Before the first segment and/or the second segment are rotated to cause the segments to abut, adhesive can be applied in the groove to secure the second segment to the first segment once they come into contact with one another. FIG. 3D shows the result of rotating the first segment and/or the second segment. In the FIG. 3D, the first segment abuts the second segment. As mentioned, this geometry can be fixed with the application of an adhesive in the groove between the two segments. The dotted line in FIG. 3D is a nominal (fictitious) extension of the back side of the first segment. The excess volume 172 of the second segment 168 below the dotted line is preferably cut off so as to achieve a flat back side. In so doing, the edge of the second segment is thinned causing a reduction in the thickness of the edge. In one embodiment, the edge is reduced in thickness by greater than 2%, but less than 10%. Other suitable ranges are also possible. FIG. 3E shows the result of cutting off the excess volume 172. The result is a tapered edge that is conducive to the application of drywall compound. The dotted line in FIG. 3E is a nominal (fictitious) extension of the front side of the first segment that illustrates the degree of tapering. The thickness 174 of the edge of the second segment has been reduced.

The step of thinning includes using a circular saw to cut out drywall material from the second segment. Alternatively, other tools can be used to thin the edge, such as a router to rout out drywall material from the second segment.

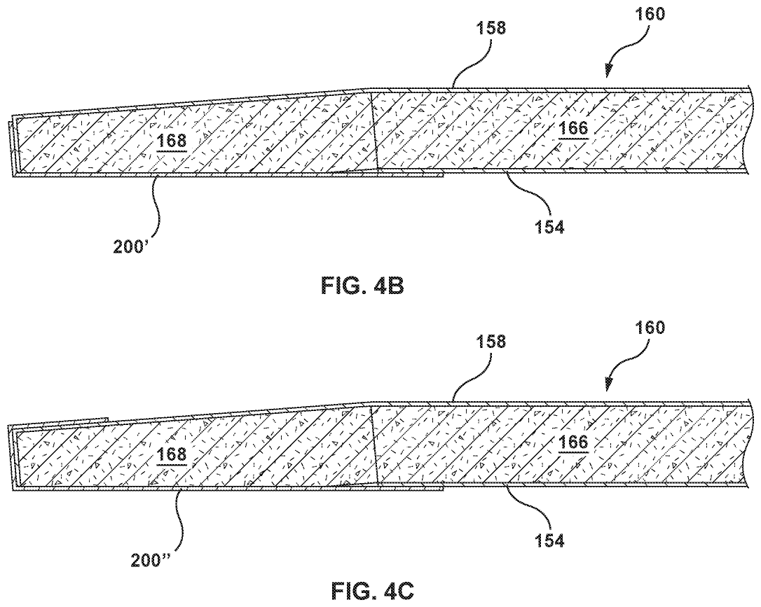

After the step of thinning, the resultant tapered board can be treated further with the addition of paper or tape to reinforce the seam where the first and second segments abut. With reference to FIG. 4A-C, three different embodiments corresponding to three different areas where the paper or tape can be applied are shown. In all three figures, the paper or tape cover the seam on the back side. In FIG. 4A, paper or tape 200 is disposed strictly on the back side 202 of the tapered board 204 and covers an area on either side of the seam. The paper or tape 200 is applied on top of the framing drywall liner 206 that is severed at the seam.

Alternatively, as shown in FIG. 4B, tape or paper 200′ is applied across the seam on the back side and up vertically on the edge.

In yet another alternative, as shown in FIG. 4C, since it it is difficult for the tape or paper to adhere directly to the gypsum layer itself, the tape or paper 200″ is applied across the seam on the back side, up vertically on the edge and then across on the tapered portion of the front side. Thus, the tape or paper 200″ wraps around the edge of the board. It will be appreciated that because of the tapering, after compound is applied, the tape or paper 200″ will not be visible. Also, it is contemplated that the additional structural rigidity provided by the alternative of FIG. 4C, may obviate the need for adhesive within the groove 162.

The inventor contemplates that for a single drywall board one or more ends of the board can be subjected to the tapering system and method described above. For example, a rectangular drywall board has four edges on the finishing side of the board, two being opposite and parallel and the other two being opposite and parallel. Correspondingly, such a rectangular drywall board has four ends, or regions on the finishing side that are proximal to these four edges. In a typical drywall board, only two ends, opposite to one another, arrive from the factory already tapered. If one of these ends is cut such that the taper is eliminated from the board, the principles of the present invention can be used to restore the single taper. Similarly, if both factory tapers are cut, two new tapers can be formed using the principles of the present invention to thereby restore the two tapers. In addition, and if convenient, one or both ends of the drywall board that were not tapered at the factory can also be tapered using the principles of the present invention. Thus, anywhere from one to four new tapers can be formed for a rectangular board according the method and system described above.

The present invention has been described with respect to several embodiments, although a person of skill in the art will appreciate that other embodiments and variations are possible. It is not desired to limit the invention to the exact construction and operation illustrated and described, and accordingly all suitable modifications and equivalents may be resorted to, falling within the scope of the claims.

What is claimed is:

1. A method of tapering an end of a drywall board, the method comprising:
providing a drywall board having a back side with a framing drywall liner, a front side with a finishing drywall liner, and an edge;
creating a groove on the back side of the drywall board parallel to the edge, wherein the groove a) has a void therein, b) has a depth that extends to but does not sever the finishing drywall liner, and c) gives rise to a hinge that includes the finishing drywall liner, said hinge connecting a first segment of the drywall board on one side of the groove to a second segment of the drywall board on another side of the groove, such that the second segment includes the edge; and
closing the void in the groove by rotating at least one of the first segment and the second segment about the hinge.

2. The method of claim 1, wherein the step of creating a groove includes creating a V-shaped groove on the back side.

3. The method of claim 2, wherein an angle of the V-shaped groove is less than five degrees.

4. The method of claim 1, wherein the step of creating a groove includes routing a hollow on the back side.

5. The method of claim 1, wherein the step of creating a groove includes using a circular saw to cut a slit on the back side.

6. The method of claim 1, further comprising:
before the step of closing, adding adhesive in the groove to secure the second segment to the first segment.

7. The method of claim 1, wherein in the step of thinning, the edge is reduced in thickness by less than 10%.

8. The method of claim 1, wherein the step of thinning includes using one of either a grinder wheel or a circular saw to cut out drywall material from the second segment.

9. The method of claim 1, wherein the step of thinning includes using a router to rout out drywall material from the second segment.

10. The method of claim 1, further comprising:
after the step of thinning, affixing at least one of paper and tape on the second segment proximal to the edge.

11. The method of claim 10, wherein in the step of closing, a seam is formed between the first segment and the second segment, further comprising:
after the step of thinning, affixing at least one of paper and tape on the second segment proximal to the edge and on the first segment, so that the at least one of paper and tape crosses the seam.

12. The method of claim 1, further comprising:
after the step of thinning, affixing at least one of paper and tape on the second segment such that the at least one of paper and tape is affixed to the front and back of the second segment to wrap around the edge.

13. The method of claim 12, wherein in the step of closing, a seam is formed between the first segment and the second segment, further comprising:
after the step of thinning, affixing the at least one of paper and tape on the first segment, so that the at least one of paper and tape crosses the seam.

14. The method of claim 1, wherein the thickness of the edge is less than the thickness of a center of the board by not greater than 10%.

15. The method of claim 1, comprising at least one of paper and tape on the second segment proximal to the edge.

16. The method of claim 1, further comprising thinning the edge by removing drywall material from the back side of the second segment to thereby make a tapered end that includes the edge

17. A drywall board having a tapered end proximal to an edge of the board, comprising:
a first gypsum-containing segment;
a second gypsum-containing segment abutting the first segment at a boundary therebetween;
a finishing liner integrally covering an area on a front side of the first segment and a front side of the second segment; and
a seam located where the first segment and the second segment abut, said seam being parallel to the edge and on a back side of the first and second segments.

18. The drywall board of claim 17, wherein the thickness of the board at the edge is between 2% and 10% less than the thickness of the board at the seam.

19. The drywall board of claim 18, wherein drywall paper is disposed near the edge and on the back side of the second segment.

20. The drywall board of claim 17, further comprising an adhesive located at the boundary, said adhesive affixing the second segment to the first segment

21. The drywall board with a tapered end produced by the method of claim 1.

22. The drywall board of claim 21 comprising adhesive in the groove to secure the second segment to the first segment.
